(19) United States
(12) Patent Application Publication
(10) Pub. No.: US 2025/0183329 A1
(43) Pub. Date: Jun. 5, 2025

(54) SEPARATOR FOR FUEL CELL AND UNIT CELL FOR FUEL CELL INCLUDING THE SAME

(71) Applicants: HYUNDAI MOTOR COMPANY, SEOUL (KR); KIA CORPORATION, SEOUL (KR)

(72) Inventor: Seong Il Heo, Seongnam-si (KR)

(21) Appl. No.: 18/593,168

(22) Filed: Mar. 1, 2024

(30) Foreign Application Priority Data
Dec. 4, 2023 (KR) 10-2023-0173652

(51) Int. Cl. H01M 8/0258; H01M 8/0273; H01M 8/04029; H01M 8/10; H01M 8/1004; H01M 8/2483

(52) U.S. Cl. CPC H01M 8/0258; H01M 8/0273; H01M 8/04029; H01M 8/1004; H01M 8/2483; H01M 2008/1095

(57) ABSTRACT

An enhanced fuel cell separator design prevents gasket burrs during gasket line formation and facilitates straight-line movement of reaction gas and water, thereby improving overall gas flow. The fuel cell unit incorporates the fuel cell separator featuring a reaction surface, a cooling surface, a central reaction region, and surrounding manifolds.

### CROSS REFERENCE TO RELATED APPLICATIONS

The present application claims priority to Korean Patent Application No. 10-2023-0173652, filed Dec. 4, 2023, the entire contents of which is incorporated herein for all purposes by this reference.

### BACKGROUND

### Field

The disclosure relates to a separator for a fuel cell and a fuel cell stack including the same, and more specifically, to a separator for a fuel cell that improves the structure of a separator to prevent gasket burrs from forming when forming a gasket line and to allow a reaction gas to flow in and out in a straight line, thereby facilitating the movement of the reaction gas and generated water, and a unit cell for a fuel cell including the same

### Description of the Related Art

A fuel cell, which is a type of power generation device that converts chemical energy of a fuel into electric energy through electrochemical reaction in a stack, not only provide driving power for industrial use, household use, and vehicles, but can also be used to power for small electronic devices such as portable devices. In recent years, the use of the fuel cell has been gradually increasing as a highly efficient and clean energy source.

FIG. 1 is a diagram showing the configuration of a typical fuel cell stack.

As seen in FIG. 1, in a unit cell constituting a typical fuel cell stack, a membrane electrode assembly (MEA) is located at the innermost side, and the membrane electrode assembly 10 is composed of a polymer electrolyte membrane 11 capable of moving hydrogen cations (protons) and a catalyst layer coated on both sides, that is, a fuel electrode anode 12 and air electrode cathode 13, of the electrolyte membrane so that hydrogen and oxygen can react.

Furthermore, a pair of gas diffusion layers (GDLs) 20 are stacked on the external portion of the membrane electrode assembly 10, that is, on the external portion where the fuel electrode 12 and air electrode 13 are located, and a separator assembly 30 having a flow field formed therein to supply fuel and discharge water generated by the reaction is positioned outside the gas diffusion layer 20 with a gasket 40 interposed therebetween.

Here, the separator assembly 30 is formed by bonding an anode separator 32 provided on the anode and a cathode separator 31 provided on the cathode while facing each other.

Meanwhile, a fuel cell stack is formed by stacking a plurality of unit cells, and an end plate 50 for supporting and fixing each of the above-described components is coupled to the outermost side of the stacked unit cells.

Here, the anode separator 32 provided in any one unit cell is stacked to face the cathode separator 31 of another unit cell provided adjacent to the unit cell.

Accordingly, the separator assembly 30, in which the cathode separator 31 and the anode separator 32 of adjacent unit cells provided to face each other are integrated, is used to construct a unit cell to smoothly perform the stacking process of the unit cells and maintain the alignment of the unit cells.

Here, the anode separator 32 and cathode separator 31 constituting the separator assembly 30 are bonded and integrated, so that manifolds communicate with each other, and each reaction region is configured in a similar shape to be provided at the same position.

Meanwhile, in the separator assembly 30, the plurality of manifolds and reaction regions are spaces in which reactant gas or cooling water is introduced, discharged, or flows, and an airtight line is formed by the gasket 40 along the circumference of the plurality of manifolds and reaction regions for airtightness.

In general, the airtight line is formed by injecting a gasket 40 made of rubber to a predetermined thickness on the reaction surfaces of the cathode separator 31 and anode separator 32 and a cooling surface of at least one of the cathode separator 31 and anode separator 32.

For example, the gasket is not formed on the cooling surface of the cathode separator 31, but may be formed in various forms on the reaction surface of the cathode separator 31 and anode separator 32, and the cooling surface of the anode separator 32.

FIG. 2A is a diagram showing a reaction surface of a cathode separator constituting a typical fuel cell stack, FIG. 2B is a diagram showing a cooling surface of a cathode separator constituting a typical fuel cell stack, FIG. 3A is a diagram showing a reaction surface of an anode separator constituting a typical fuel cell stack, and FIG. 3B is a diagram showing a cooling surface of an anode separator constituting a typical fuel cell stack.

As shown in FIG. 2A to FIG. 3B, the cathode separator 31 and anode separator 32 constituting a typical fuel cell stack have a reaction region R in which a flow field through which a reaction gas flows is formed in the central region, and a plurality of manifolds 31a, 31b is formed on both sides of the reaction region R. Here, six manifolds 31a, 31b are provided, and hydrogen, air, or cooling water is introduced or discharged through each manifold.

Here, various types of gaskets 40 using gasket materials are formed at the edges of the plurality of manifolds 31a, 31b and reaction region R to maintain an airtight line.

Meanwhile, a plurality of reaction gas inlet holes 31c, 32c is formed in the cathode separator 31 and anode separator 32 through which the reactant gas flowing from the manifolds 31a, 31b flows into the reaction region R. Here, a gasket support 41 branching from the gasket line is formed between the adjacent reaction gas inlet holes 31c, 32c to induce the flow of the reaction gas and maintain a surface pressure.

However, the gasket support 41 has a difficult structure, which causes problems with injection defects such as gasket burrs during gasket injection. Injection defects occurring in the gasket support 41 block the flow field formed from the reaction gas inlet hole or narrow the cross-sectional area of the flow field, preventing the reaction gas from flowing smoothly or the generated water from being discharged smoothly.

The information disclosed in this Background of the Invention section is only for enhancement of understanding of the general background of the disclosure and should not be taken as an acknowledgement that this information forms the prior art already known to a person skilled in the art.

### SUMMARY

The disclosure provides a separator for a fuel cell that improves the structure of a separator to prevent gasket burrs from forming when forming a gasket line and to allow a reaction gas to flow in and out in a straight line, thereby facilitating the movement of the reaction gas and generated water, and a unit cell for a fuel cell including the same.

The technical objects to be achieved by the disclosure are not limited to the technical objects mentioned above, and other technical objects not mentioned may be clearly understood by those skilled in the art from the following descriptions.

A separator for a fuel cell according to an embodiment of the disclosure is a separator in which a reaction surface is formed on one side, a cooling surface is formed on the other side, a reaction region is formed in a central region, and a plurality of manifolds is formed around the reaction region, wherein, among the plurality of manifolds, one of the manifolds formed on one side of the reaction region is a reaction gas inlet manifold through which a reaction gas is introduced, a plurality of reaction gas inlet holes is formed between the reaction gas inlet manifold and the reaction region such that the reaction gas flowing from the reaction gas inlet manifold through the cooling surface passes through the reaction surface and then flows into the reaction region, an inlet flow field plate is disposed on the reaction surface to prevent deformation of the separator while forming a flow field through which the reaction gas flows between the plurality of reaction gas inlet holes and the reaction region.

The plurality of reaction gas inlet holes is formed in a line at a predetermined distance apart from each other along a width direction of the separator, a gasket line is formed on the reaction surface around the plurality of manifolds to form an airtight line along an edge of the manifold, the gasket line is not formed between the adjacent reaction gas inlet holes.

The inlet flow field plate is divided into a support supported on the reaction surface and a plurality of protrusions formed by protruding from the support, and a flow field through which the reaction gas flows is formed between the adjacent protrusions.

The protrusion of the inlet flow field plate is formed in a line or island shape.

A height of the protrusion corresponds to a height of the gasket line.

The protrusion is formed at a position corresponding to a space between the adjacent reaction gas inlet holes.

An inlet forming part is formed to protrude in a direction of the reaction surface between the reaction gas inlet manifold and a plurality of reaction gas inlet holes.

The inlet forming part is formed from a point in contact with the reaction gas inlet manifold to a point in contact with the plurality of reaction gas inlet holes.

The gasket line is not formed between the reaction gas inlet manifold and the plurality of reaction gas inlet holes.

Among the plurality of manifolds, one of the manifolds formed on the other side of the reaction region is a reaction gas discharge manifold through which the reaction gas is discharged, a plurality of reaction gas discharge holes is formed between the reaction gas discharge manifold and the reaction region such that the reaction gas discharged from the reaction region through the reaction surface passes through the cooling surface and then is discharged to the reaction gas discharge manifold, an outlet flow field plate is disposed on the reaction surface to prevent deformation of the separator while forming a flow field through which the reaction gas is discharged between the plurality of reaction gas discharge holes and the reaction region.

An outlet forming part is formed to protrude in a direction of the reaction surface between the reaction gas discharge manifold and the plurality of reaction gas discharge holes.

Further, a unit cell for a fuel cell according to an embodiment of the disclosure comprises a membrane electrode assembly, a sub-gasket surrounding and supporting the membrane electrode assembly along an edge of the membrane electrode assembly, a first separator in which a first reaction surface facing the membrane electrode assembly is formed on one side, a first cooling surface is formed on the other side, a first reaction region facing the membrane electrode assembly is formed in a central region, and a plurality of first manifolds is formed on both sides of the first reaction region, a second separator in which a second reaction surface is formed to be disposed on the opposite side of the first separator with the membrane electrode assembly in between and faces the membrane electrode assembly on one side, a second cooling surface is formed on the other side, a second reaction region facing the membrane electrode assembly is formed in a central region, and a plurality of second manifolds communicating with the plurality of first manifolds is formed on both sides of the second reaction region, wherein one of the first manifolds formed on one side of the first reaction region in the first separator is a first reaction gas inlet manifold through which a first reaction gas is introduced, a plurality of first reaction gas inlet holes is formed between the first reaction gas inlet manifold and the first reaction region such that the first reaction gas flowing from the first reaction gas inlet manifold through the first cooling surface passes through the first reaction surface and then flows into the first reaction region, an inlet flow field plate is disposed on the first reaction surface to prevent deformation of the first separator while forming a flow field through which the first reaction gas flows between the plurality of first reaction gas inlet holes and the first reaction region.

The plurality of first reaction gas inlet holes formed in the first separator is formed in a line at a predetermined distance apart from each other along a width direction of the first separator perpendicular to a direction in which the first reaction gas flows, a first reaction surface gasket line is formed around the plurality of first reaction gas inlet manifolds to form an airtight line along an edge of the first reaction gas inlet manifold, the first reaction surface gasket line is not formed between the adjacent first reaction gas inlet holes.

The first inlet flow field plate is divided into a support supported on the first reaction surface and a plurality of protrusions formed by protruding from the support, and a flow field through which the first reaction gas flows is formed between the adjacent protrusions.

A first inlet forming part is formed on the first separator to protrude in a first reaction surface direction between the first reaction gas inlet manifold and a plurality of first reaction gas inlet holes.

The first inlet forming part is formed from a point in contact with the first reaction gas inlet manifold to a point in contact with the plurality of first reaction gas inlet holes.

The first reaction surface gasket line is not formed between the first reaction gas inlet manifold and the plurality of first reaction gas inlet holes.

A second reaction surface gasket line forming an airtight line along an edge of a second manifold communicating with the first reaction gas inlet manifold of the first separator is formed on the second reaction surface of the second separator, an uneven part corresponding to a bent shape of at least one end of the first inlet forming part formed on the first separator is formed in the second reaction surface gasket line.

One of the second manifolds formed on one side of the second reaction region in the second separator is a second reaction gas inlet manifold through which a second reaction gas is introduced, a plurality of second reaction gas inlet holes is formed between the second reaction gas inlet manifold and the second reaction region such that the second reaction gas flowing from the second reaction gas inlet manifold through the second cooling surface passes through the second reaction surface and then flows into the second reaction region, a second inlet flow field plate is further disposed on the second reaction surface to prevent deformation of the second separator while forming a flow field through which the second reaction gas flows between the plurality of second reaction gas inlet holes and the second reaction region.

The plurality of second reaction gas inlet holes formed in the second separator is formed in a line at a predetermined distance apart from each other along a width direction of the second separator perpendicular to a direction in which the second reaction gas flows, a second reaction surface gasket line is formed around the plurality of second reaction gas inlet manifolds to form an airtight line along an edge of the second reaction gas inlet manifold, the second reaction surface gasket line is not formed between the adjacent second reaction gas inlet holes.

According to an embodiment of the disclosure, the gasket support conventionally formed between adjacent reaction gas inlet holes is omitted, and a flow field plate is placed to replace the gasket support, thereby preventing the flow field from being blocked while maintaining surface pressure. Accordingly, the effect of smooth flow of reaction gas or smooth discharge of generated water can be expected.

In addition, by improving the structure of the inlet and outlet sides of the reaction gas so that the reaction gas flows in and out in a straight line, the effect of smoothing the movement of the reaction gas and generated water can be expected.

### BRIEF DESCRIPTION OF THE FIGURES

FIG. 1 is a diagram showing the configuration of a typical fuel cell stack.

FIG. 2A is a diagram showing a reaction surface of a cathode separator constituting a typical fuel cell stack.

FIG. 2B is a diagram showing a cooling surface of a cathode separator constituting a typical fuel cell stack.

FIG. 3A is a diagram showing a reaction surface of an anode separator constituting a typical fuel cell stack.

FIG. 3B is a diagram showing a cooling surface of an anode separator constituting a typical fuel cell stack.

FIG. 4A is a diagram showing a first reaction surface of a first separator constituting a unit cell for a fuel cell according to an embodiment of the disclosure.

FIG. 4B is a diagram showing a first cooling surface of a first separator constituting a unit cell for a fuel cell according to an embodiment of the disclosure.

FIG. 5A is a diagram showing a second reaction surface of a second separator constituting a unit cell for a fuel cell according to an embodiment of the disclosure.

FIG. 5B is a diagram showing a second cooling surface of a second separator constituting a unit cell for a fuel cell according to an embodiment of the disclosure.

FIGS. 6A and 6B are diagrams showing a flow field plate constituting a unit cell for a fuel cell according to an embodiment of the disclosure.

FIG. 7A is a diagram showing a cross section of a unit cell along line A-A′ in FIG. 4A.

FIG. 7B is a diagram showing a cross section of a unit cell along line B-B′ in FIG. 4A.

FIG. 7C is a diagram showing a cross section of a unit cell along line C-C′ in FIG. 4A.

FIG. 8 is a diagram showing a first reaction surface of a first separator constituting a unit cell for a fuel cell according to another embodiment of the disclosure.

FIG. 9A is a cross-section of a unit cell along line A-A′ in FIG. 8.

FIG. 9B is a diagram showing a cross section of a unit cell along line B-B′ in FIG. 8.

FIG. 9C is a diagram showing a cross section of a unit cell along line C-C′ in FIG. 8.

FIG. 10 is a diagram showing a cross section of a unit cell along line A-A′ in FIG. 8 in a unit cell for a fuel cell according to a modified embodiment of the disclosure.

### DETAILED DESCRIPTION

Hereinafter, embodiments of the disclosure will be described in detail with reference to the attached drawings. The same or similar components are given the same reference numbers and redundant description thereof is omitted.

The suffixes “module” and “unit” of elements herein are used for convenience of description and thus may be used interchangeably and do not have any distinguishable meanings or functions.

Further, in the following description, if a detailed description of known techniques associated with the disclosure would unnecessarily obscure the gist of the disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

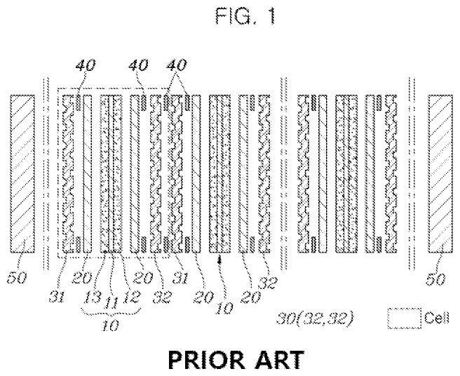

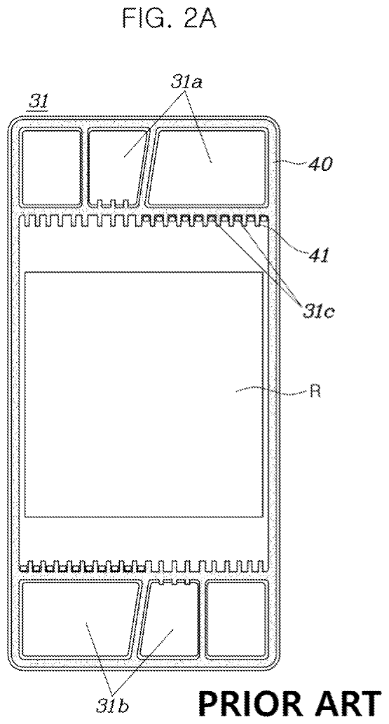

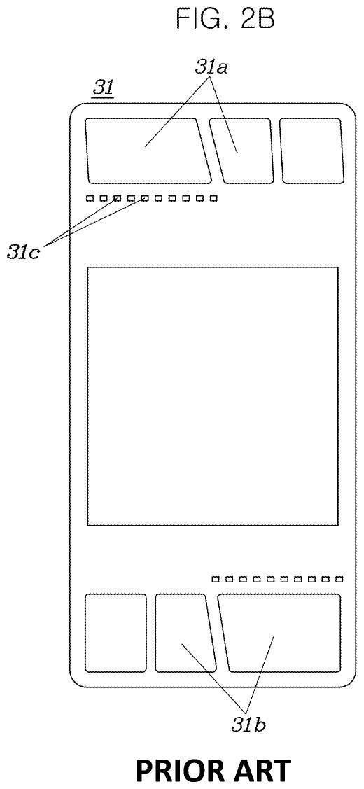

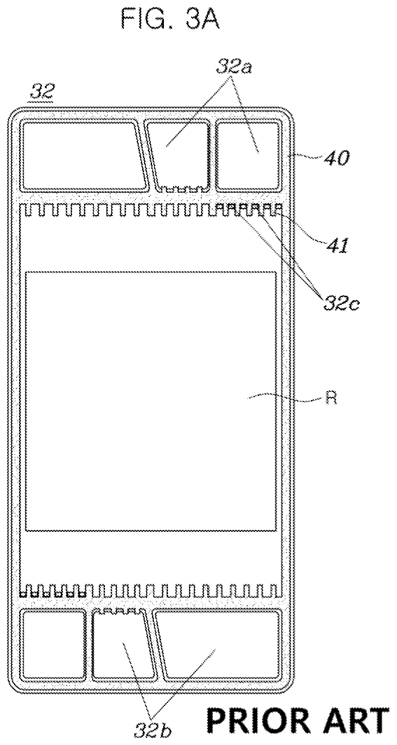

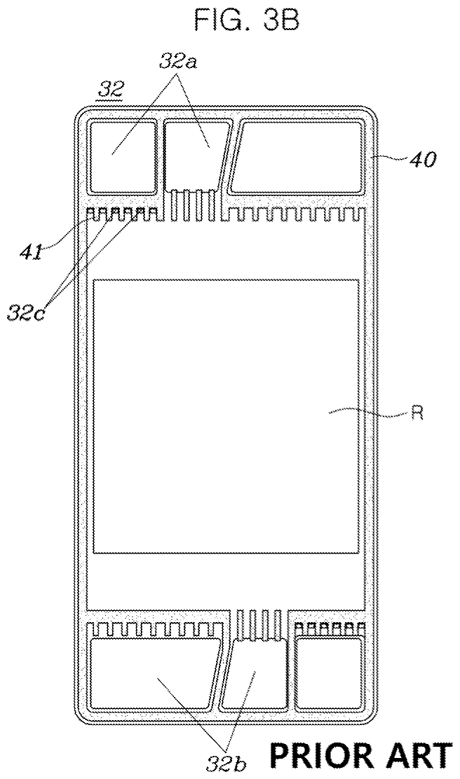

A unit cell for a fuel cell according to an embodiment of the disclosure maintains a surface pressure by changing the structure of the inflow and outflow fields of the reaction gas from the separator and the gasket structure, and also ensures that the inflow and discharge paths of the reaction gas and the discharge path of the generated water are formed in a straight line, while maintaining the structure of the unit cell constituting the typical fuel cell stack shown in FIG. 1.

As shown in FIG. 1, the unit cell for a fuel cell according to an embodiment of the disclosure includes a membrane electrode assembly 10, a pair of gas diffusion layers 20, and a pair of separators 31, 32. A fuel cell stack is formed by connecting the plurality of unit cells in series. The pair of separators 31, 32 will be described separately as a first separator 31 and a second separator 32. Here, the first separator 31 may be a cathode separator, and the second separator 32 may be an anode separator. It is apparent that an anode separator may be used as the first separator 31, and a cathode separator may be used as the second separator 32.

Meanwhile, the first separator 31 formed in one unit cell is disposed to face the second separator 32 formed in the unit cell adjacent thereto. In this embodiment, the first separators 31 and second separator 32 facing each other are stacked to form a separator assembly. Here, a frame (hereinafter referred to as “sub gasket 10a”) is provided around the membrane electrode assembly 10 to surround and support the membrane electrode assembly 10.

Therefore, in the following description, overlapping descriptions of typical fuel cell stacks and unit cells will be omitted.

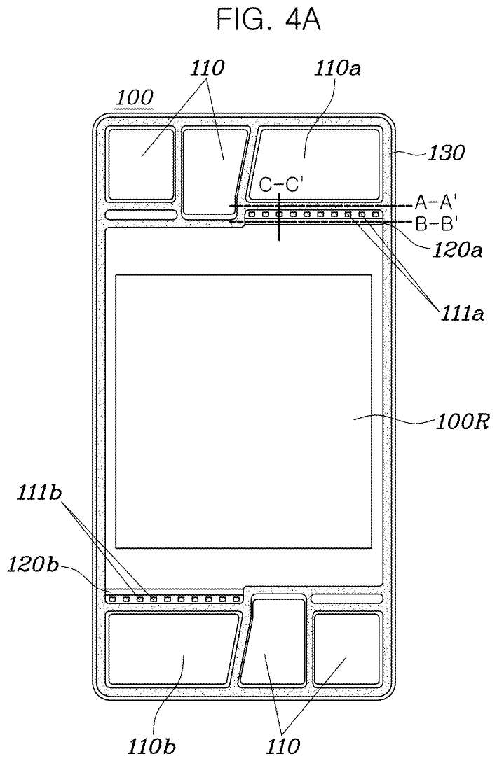

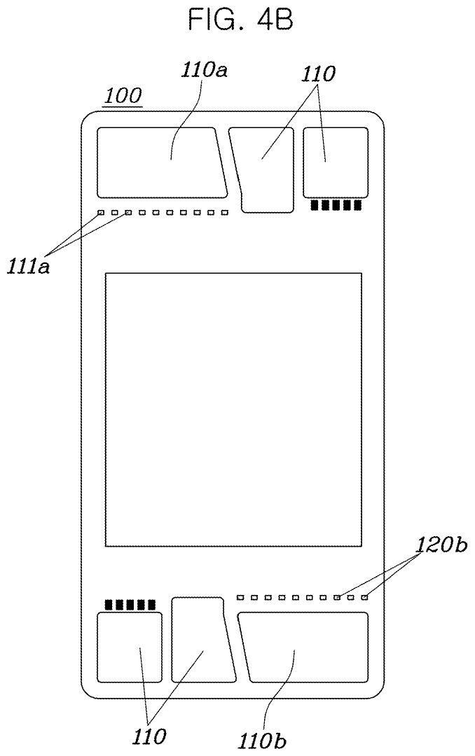

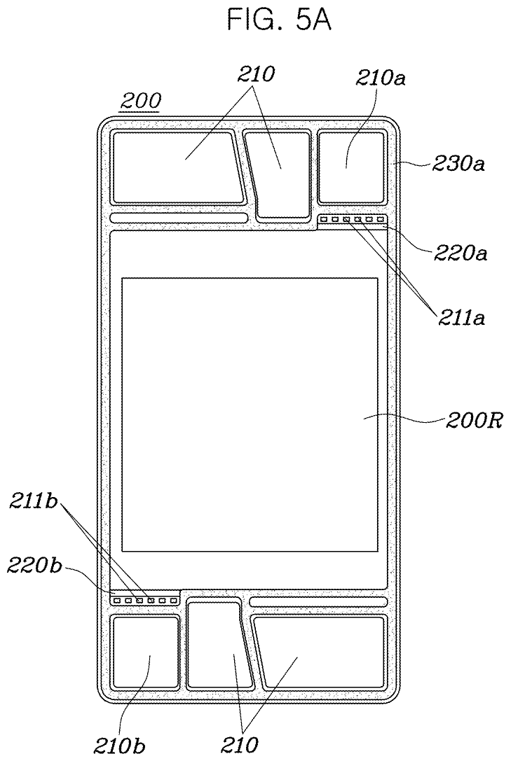

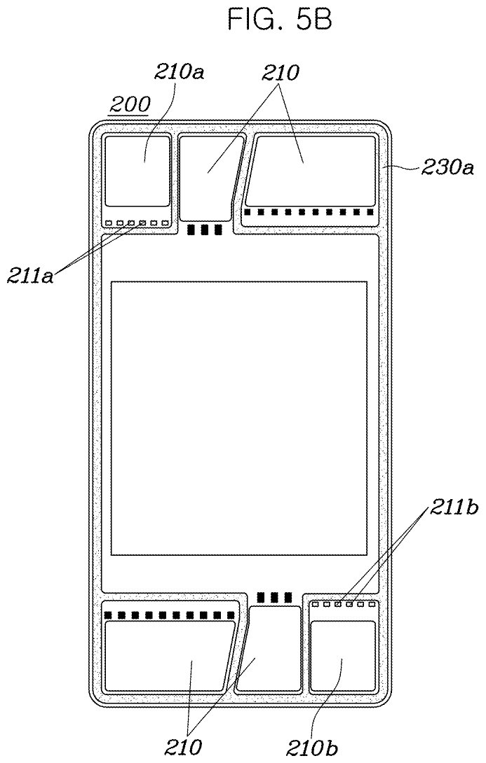

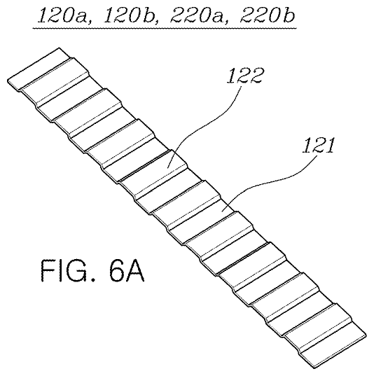

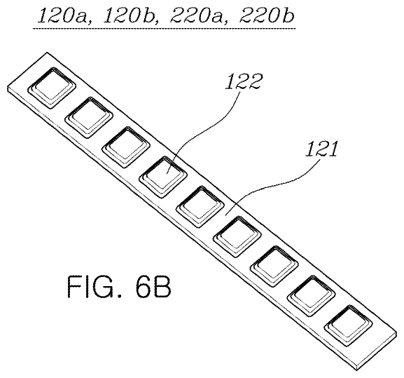

FIG. 4A is a diagram showing a first reaction surface of a first separator constituting a unit cell for a fuel cell according to an embodiment of the disclosure, FIG. 4B is a diagram showing a first cooling surface of a first separator constituting a unit cell for a fuel cell according to an embodiment of the disclosure, FIG. 5A is a diagram showing a second reaction surface of a second separator constituting a unit cell for a fuel cell according to an embodiment of the disclosure, FIG. 5B is a diagram showing a second cooling surface of a second separator constituting a unit cell for a fuel cell according to an embodiment of the disclosure, and FIGS. 6A and 6B are diagrams showing a flow field plate constituting a unit cell for a fuel cell according to an embodiment of the disclosure.

As shown in the drawing, the first separator 100 and second separator 200, which constitute a unit cell for a fuel cell according to an embodiment of the disclosure, have a reaction surface formed on one side and a cooling surface on the other side, a reaction region 100R, 200R formed in the central region, and a plurality of manifolds 110, 210 formed around the reaction region 100R, 200R, respectively.

In more detail, a unit cell for a fuel cell according to an embodiment of the disclosure comprises a membrane electrode assembly 10; a sub-gasket 10a surrounding and supporting the membrane electrode assembly 10 along an edge of the membrane electrode assembly 10; a first separator 100 in which a first reaction surface facing the membrane electrode assembly 10 is formed on one side, a first cooling surface is formed on the other side, a first reaction region 100R facing the membrane electrode assembly 10 is formed in a central region, and a plurality of first manifolds 110 is formed on both sides of the first reaction region 100R; a second separator 200 in which a second reaction surface is formed to be disposed on the opposite side of the first separator 100 with the membrane electrode assembly 10 in between and faces the membrane electrode assembly 10 on one side, a second cooling surface is formed on the other side, a second reaction region 200R facing the membrane electrode assembly 10 is formed in a central region, and a plurality of second manifolds 210 communicating with the plurality of first manifolds 110 is formed on both sides of the second reaction region 200R.

Here, the first separator 100 may be a cathode separator, and the second separator 200 may be an anode separator.

Meanwhile, on the reaction surfaces of the first separator 100 and second separator 200 and the cooling surface of the second separator 200, gasket lines 130, 230a, 230b forming airtight lines are formed around the plurality of manifolds 110, 210 along the edges of the manifolds 110, 210, and no gasket lines are formed on the cooling surface of the first separator 100.

Here, one of the manifolds 110, 210 formed on one side of the reaction regions 100R, 200R, among the plurality of manifolds 110, 210, is an reaction gas inlet manifold 110a, 210a into which the reaction gas flows. For example, a first reaction gas inlet manifold 110a through which air flows into the reaction gas is formed on the first separator 100, and a second reaction gas inflow manifold 210a through which hydrogen flows into the reaction gas is formed on the second separator 200.

In addition, between the reaction gas inlet manifolds 110a, 210a and the reaction regions 100R, 200R, a plurality of reaction gas inlet holes 111a, 211a is formed such that the reaction gas flowing from the reaction gas inlet manifolds 110a, 210a through the cooling surface passes through the reaction surface and then into the reaction region. For example, the first separator 100 is formed with a first reaction gas inlet hole 111a through which air passes as the reaction gas, and the second separator 200 is formed with a second reaction gas inlet hole through which hydrogen passes as the reaction gas.

Here, the plurality of first reaction gas inlet holes 111a and plurality of second reaction gas inlet holes 211a formed in the first separator 100 and second separator 200 are preferably formed in a line at a predetermined distance apart from each other along the width direction of the first separator 100 and second separator 200 perpendicular to the direction in which the first and second reaction gases flow.

Meanwhile, in the disclosure, in order to prevent gasket burrs due to injection defects during injection molding of the gasket lines 130, 230a, 230b, the gasket support formed on a conventional separator is omitted, and a flow field plate is disposed to replace the role of the gasket support.

For example, on the reaction surfaces of the first separator 100 and second separator 200, a flow field through which the reaction gas flows between the plurality of reaction gas inlet holes 111a, 211a and the reaction regions 100R, 200R is formed, and inlet flow field plates 120a, 220a are disposed to prevent deformation of the separators 100, 200. Therefore, on the reaction surfaces of the first separator 100 and second separator 200, the gasket lines 130, 230a forming airtight lines are formed around the plurality of manifolds 110, 210 along the edges of the manifolds 110, 120. However, a gasket line like a conventional gasket support is not formed between adjacent first reaction gas inlet holes 111a and between adjacent second reaction gas inlet holes 211a.

Meanwhile, the inlet flow field plates 120a, 220a form a flow field through which the reaction gas flows and is divided into a support 121 supported on the reaction surface to maintain the surface pressure with the adjacent membrane electrode assembly 10, preferably with the sub-gasket 10a, and a plurality of protrusions 122 formed by protruding from the support 121. Therefore, a flow field through which the reaction gas flows is formed between the adjacent protrusions 122.

Here, the shape of the protrusion 122 may be implemented in various forms that can maintain surface pressure while forming a flow field. For example, the shape of the protrusion 122 may be formed in a line shape as shown in FIG. 6A or in an island shape as shown in FIG. 6B.

However, the height of the protrusion 122 is preferably formed to correspond to the height of the gasket line 130 in order to form a uniform surface pressure. Preferably, the height of the protrusion 122 is formed to correspond to the height of the gasket line 130 in a compressed state according to the stacking of the fuel cell stack.

In addition, the protrusion 122 is preferably formed at a position corresponding to a space between the adjacent reaction gas inlet holes 111a, 211a for smooth flow of the reaction gas.

Meanwhile, the flow field plate may be disposed in a region where the reaction gas flows in and may also be disposed in a region where the reaction gas is discharged.

In more detail, one of the manifolds 110, 210 formed on the other side of the reaction region 100R, 200R, among the plurality of manifolds 110, 210, is a reaction gas discharge manifold 110b, 210b through which the reaction gas is discharged. For example, a first reaction gas discharge manifold 110b through which air is discharged as the reaction gas is formed on the first separator 100, and a second reaction gas discharge manifold 210b through which hydrogen is discharged as the reaction gas is formed on the second separator 200.

In addition, between the reaction gas discharge manifolds 110b, 210b and the reaction regions 100R, 200R, a plurality of reaction gas discharge holes 111b, 211b is formed to allow the reaction gas discharged from the reaction region 100R, 200R through the reaction surface to pass through the cooling surface and then discharge the reaction gas to the reaction gas discharge manifold 110b, 210b. For example, the first separator 100 is formed with the first reaction gas discharge hole 111b through which air passes as the reaction gas, and the second separator 200 is formed with the second reaction gas discharge hole 211b through which hydrogen passes as the reaction gas.

Therefore, on the reaction surfaces of the first separator 100 and second separator 200, a flow field through which the reaction gas flows between the plurality of reaction gas discharge holes 111b, 211b and the reaction regions 100R, 200R is formed, and outlet flow field plates 120b, 220b are disposed to prevent deformation of the separators 100, 200. Therefore, on the reaction surfaces 100R, 230R of the first separator 100 and second separator 200, the gasket lines 130, 230a forming airtight lines are formed around the plurality of manifolds 110, 210 along the edges of the manifolds 110, 210. However, a gasket line like a conventional gasket support is not formed between adjacent first reaction gas inlet holes 111a and between adjacent second reaction gas inlet holes 211a.

Here, the outlet flow field plates 120b, 220b, like the inlet flow field plates 120a, 220a, are formed by being divided into the support 121 and the protrusion 122.

A path through which air flows as the reaction gas in a unit cell for a fuel cell according to an embodiment of the disclosure configured as described above will be described.

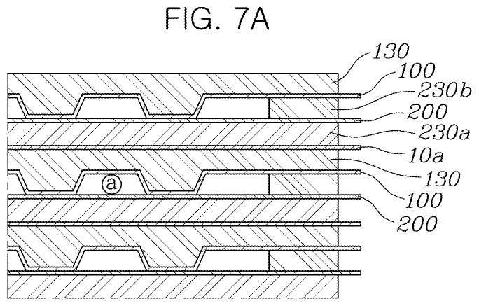

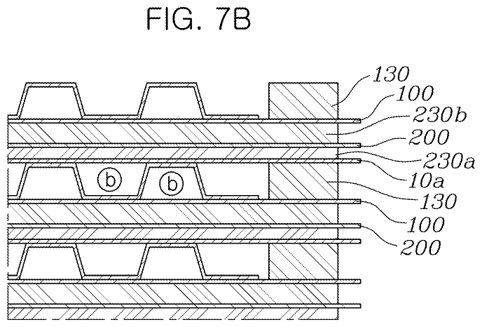

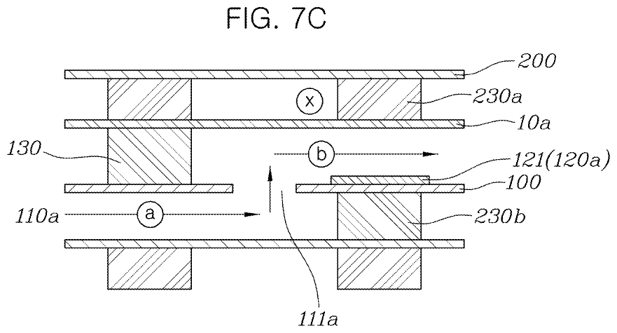

FIG. 7A is a diagram showing a cross section of a unit cell along line A-A′ in FIG. 4A, FIG. 7B is a diagram showing a cross section of a unit cell along line B-B′ in FIG. 4A, and FIG. 7C is a diagram showing a cross section of a unit cell along line C-C′ in FIG. 4A.

As shown in FIGS. 7A to 7C, the air supplied through the first reaction gas inlet manifold 110a flows into a space a between the cooling surface of the first separator 100 and the cooling surface of the second separator 200 and then passes through the first reaction gas inlet hole 111a and flows into the reaction surface of the first separator 100. Afterwards, the air passes through a space b between the protrusions 122 of the first inlet flow field plate 120a and then flows into the reaction region 100R.

In this way, the smooth flow of the reaction gas can be ensured according to the arrangement of the first inlet flow field plate 120a, and the first separator 100 can be prevented from being deformed by the pressure applied when stacking the fuel cell stack.

Meanwhile, in the disclosure, the path through which the reaction gas flows into the reaction region through the reaction gas inlet manifold or the path through which the reaction gas is discharged from the reaction region through the reaction gas discharge manifold is formed to be straight, so that the structure of the separator can be partially improved to facilitate the inflow and discharge of reaction gas.

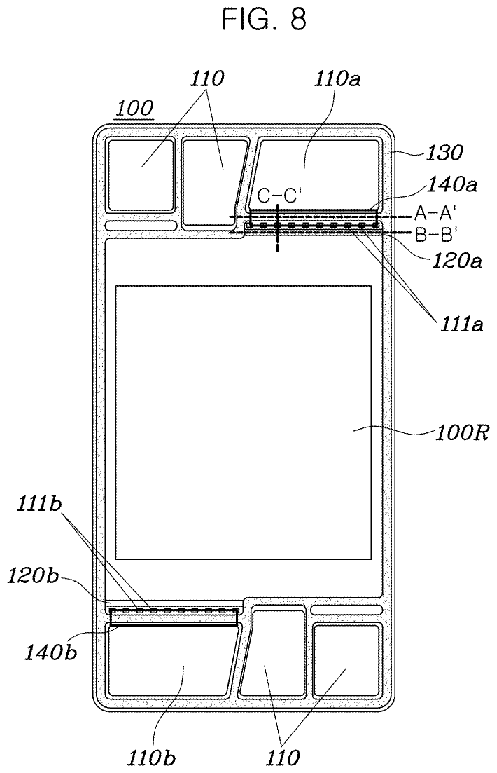

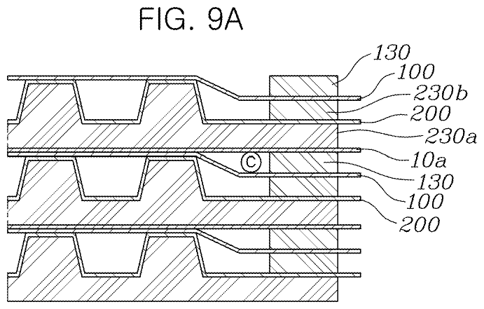

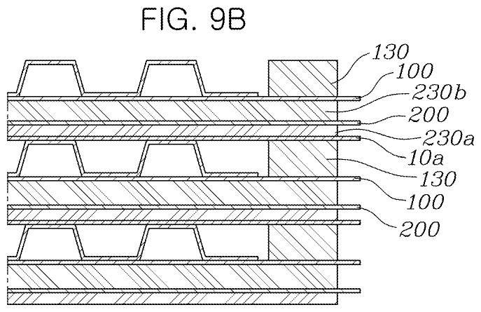

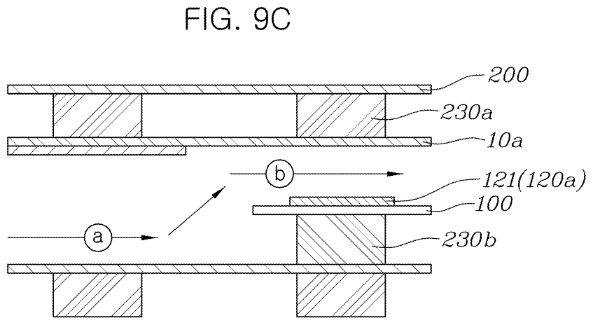

FIG. 8 is a diagram showing a first reaction surface of a first separator constituting a unit cell for a fuel cell according to another embodiment of the disclosure, FIG. 9A is a cross-section of a unit cell along line A-A′ in FIG. 8, FIG. 9B is a diagram showing a cross section of a unit cell along line B-B′ in FIG. 8, and FIG. 9C is a diagram showing a cross section of a unit cell along line C-C′ in FIG. 8.

As shown in FIGS. 8 and 9A to 9C, in the separator 100 for a fuel cell according to another embodiment of the disclosure, an inlet forming part 140a is formed to protrude in a direction of the reaction surface between the reaction gas inlet manifold 110a and the plurality of reaction gas inlet holes 111a. For example, a first inlet forming part 140a is formed in the first separator 100, and a second inlet forming part (not shown) is formed in the second separator 200. Here, the first inlet forming part 140a and second inlet forming part (not shown) formed on the first separator 100 and second separator 200 are formed in the same/similar form, so that in order to avoid redundant description, the description will be based on the first separator 100.

In addition, the first inlet forming part 140a is preferably formed from a point in contact with the first reaction gas inlet manifold 110a to a point in contact with a plurality of first reaction gas inlet holes 111a.

Here, it is preferable that the first inlet forming part 140a is preferably formed by forming the entire area from the point in contact with the first reaction gas inlet manifold 110a to the point in contact with the plurality of first reaction gas inlet holes 111a. In particular, the height of the first inlet forming part 140a, like the first inlet flow field plate 120a, is preferably formed to correspond to the height of the gasket line 130 to form a uniform surface pressure. Preferably, the height of the first inlet forming part 140a is preferably formed to correspond to the height of the gasket line 130 in a compressed state as the fuel cell stack is stacked.

Accordingly, no gasket line is formed between the first reaction gas inlet manifold 110a and the plurality of first reaction gas inlet holes 111a.

Meanwhile, the forming part may be formed in a region where the reaction gas flows in and may also be formed in a region where the reaction gas is discharged.

In more detail, the first outlet forming part 140b is preferably formed from a point in contact with the first reaction gas discharge manifold 110b to a point in contact with the plurality of first reaction gas discharge holes 111b.

Accordingly, the gasket line is not formed between the first reaction gas discharge manifold 110b and the plurality of first reaction gas discharge holes 111b.

A path through which air flows into the reaction gas in a unit cell for a fuel cell according to another embodiment of the disclosure configured as described above will be described.

As shown in FIGS. 9A to 9C, the air supplied through the first reaction gas inlet manifold 110a flows into a space a between the cooling surface of the first separator 100 and the cooling surface of the second separator 200 and then passes through the first reaction gas inlet hole 111a and flows into the reaction surface of the first separator 100. Afterwards, the air passes through a space b between the protrusions of the first inlet flow field plate 120a and then flows into the reaction region 100R.

Here, as the first inlet forming part 140a is formed on the first separator 100 from a point in contact with the first reaction gas inlet manifold 110a to a point in contact with the plurality of first reaction gas inlet holes 111a, the first inlet forming part 140a faces the sub-gasket 10a, the height of the passage through which the first reaction gas flows is expanded. Accordingly, while passing through the first reaction gas inlet hole 111a, the path of the first reaction gas is not bent at a right angle, but maintains a straight shape, so that smooth flow of the first reaction gas can be ensured, and the first separator 100 is prevented from being deformed by pressure applied when stacking the fuel cell stack.

Meanwhile, in another embodiment of the disclosure described above, when forming the inlet forming part 140a and outlet forming part 140b, a bent shape is formed at both ends, and an inevitable space like c in FIG. 9A is formed due to the generated bent shape. The space c generated in this way had a problem in that the sub-gasket 10a sags downward in that region due to the pressure applied when stacking the fuel cell stack, resulting in leakage.

Therefore, in the disclosure, the shape of the gasket line can be partially improved to solve this problem.

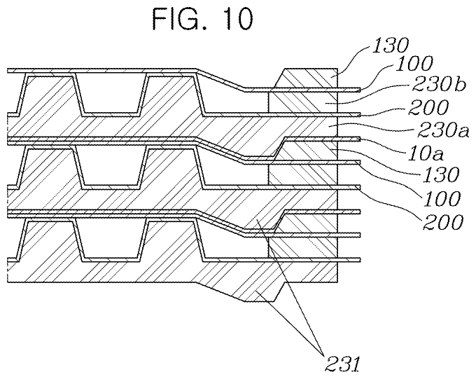

FIG. 10 is a diagram showing a cross section of a unit cell along line A-A′ in FIG. 8 in a unit cell for a fuel cell according to a modified embodiment of the disclosure.

As shown in FIG. 10, a second reaction surface gasket line 230a forming an airtight line along the edge of the second manifold 210 communicating with the first reaction gas inlet manifold 110a of the first separator 100 is formed on the second reaction surface of the second separator 200. Here, an uneven part 231 corresponding to the bent shape of at least one end of the first inlet forming part 140a formed on the first separator 100 is formed in the second reaction surface gasket line 230a. Here, the uneven part 231 is preferably formed so that the sub-gasket 10a faces the first separator 100. Therefore, the effect of preventing the formation of an unavoidable space such as c in FIG. 9A can be expected.

Here, since the sub-gasket 10a is provided in the form of a film, the height level of the uneven part 231 can be deformed (less than 1 mm), so the sub-gasket 10a is bent by the uneven part 231 to face the first separator 100.

Although the disclosure has been illustrated and described in connection with the preferred embodiments and the accompanying drawings, it is not limited thereto but defined by the appended claims. Accordingly, it will be readily understood by those skilled in the art that various modifications and changes can be made thereto without departing from the spirit and scope of the disclosure defined by the appended claims.

1. A separator for a fuel cell comprising:
a reaction surface formed on a first side of the separator;
a cooling surface formed on a second side of the separator;
a reaction region formed in a central region of the separator; and
a plurality of manifolds formed around the reaction region,
wherein one of the plurality of manifolds is a reaction gas inlet manifold formed on a first side of the reaction region, and through which a reaction gas is introduced;
a plurality of reaction gas inlet holes formed between the reaction gas inlet manifold and the reaction region such that the reaction gas flowing from the reaction gas inlet manifold through the cooling surface passes through the reaction surface and then flows into the reaction region; and
an inlet flow field plate disposed on the reaction surface configured to prevent deformation of the separator while forming a flow field through which the reaction gas flows between the plurality of reaction gas inlet holes and the reaction region.

2. The separator of claim 1, wherein the plurality of reaction gas inlet holes are formed in a line at a predetermined distance apart from each other along a width direction of the separator; and
a gasket line is formed on the reaction surface around the plurality of manifolds to form an airtight line along an edge of the manifold, wherein the gasket line is not formed between adjacent reaction gas inlet holes of the plurality of reaction gas inlet holes.

3. The separator of claim 2, wherein the inlet flow field plate is divided into a support supported on the reaction surface and a plurality of protrusions protruding from the support, and a flow field through which the reaction gas flows is formed between adjacent protrusions of the plurality of protrusions.

4. The separator of claim 3, wherein each of the plurality of protrusions of the inlet flow field plate has a line or island shape.

5. The separator of claim 3, wherein a height of each of the plurality of protrusions corresponds to a height of the gasket line.

6. The separator of claim 3, wherein each of the plurality of protrusions positioned at a space between each of the adjacent reaction gas inlet holes.

7. The separator of claim 2, wherein an inlet forming part protrudes in a direction of the reaction surface between the reaction gas inlet manifold and the plurality of reaction gas inlet holes.

8. The separator of claim 7, wherein the inlet forming part extends from a point in contact with the reaction gas inlet manifold to a point in contact with the plurality of reaction gas inlet holes.

9. The separator of claim 7, wherein the gasket line is not formed between the reaction gas inlet manifold and the plurality of reaction gas inlet holes.

10. The separator of claim 1, wherein one of the plurality of manifolds formed on a second side of the reaction region is a reaction gas discharge manifold through which the reaction gas is discharged;
wherein a plurality of reaction gas discharge holes are formed between the reaction gas discharge manifold and the reaction region such that the reaction gas discharged from the reaction region through the reaction surface passes through the cooling surface and then is discharged to the reaction gas discharge manifold; and
wherein an outlet flow field plate is positioned on the reaction surface to prevent deformation of the separator while forming a flow field through which the reaction gas is discharged between the plurality of reaction gas discharge holes and the reaction region.

11. The separator of claim 10, wherein an outlet forming part protrudes in a direction of the reaction surface between the reaction gas discharge manifold and the plurality of reaction gas discharge holes.

12. A unit cell for a fuel cell, comprising:
a membrane electrode assembly;
a sub-gasket surrounding and supporting the membrane electrode assembly along an edge of the membrane electrode assembly;
a first separator having:
a first reaction surface facing the membrane electrode assembly on a first side of the first separator;
a first cooling surface on a second side of the first separator;
a first reaction region facing the membrane electrode assembly in a central region of the first separator; and
a plurality of first manifolds formed on both sides of the first reaction region; and
a second separator having:
a second reaction surface facing the first side of the first separator with the membrane electrode assembly positioned in between and facing the membrane electrode assembly on a first side of the second separator;
a second cooling surface formed on a second side of the second separator;
a second reaction region facing the membrane electrode assembly formed in a central region of the second separator; and
a plurality of second manifolds communicating with the plurality of first manifolds formed on both sides of the second reaction region;
wherein one of the plurality of first manifolds formed on a first side of the first reaction region in the first separator is a first reaction gas inlet manifold through which a first reaction gas is introduced;
a plurality of first reaction gas inlet holes formed between the first reaction gas inlet manifold and the first reaction region such that the first reaction gas flowing from the first reaction gas inlet manifold through the first cooling surface passes through the first reaction surface and then flows into the first reaction region; and
a first inlet flow field plate positioned on the first reaction surface and configured to prevent deformation of the first separator while forming a flow field through which the first reaction gas flows between the plurality of first reaction gas inlet holes and the first reaction region.

13. The unit cell of claim 12, wherein the plurality of first reaction gas inlet holes formed in the first separator are formed in a line at a predetermined distance apart along a width direction of the first separator, perpendicular to a direction in which the first reaction gas flows;
a first reaction surface gasket line is formed around the plurality of first reaction gas inlet manifolds to form an airtight line along an edge of the first reaction gas inlet manifold; and
the first reaction surface gasket line is not formed between the adjacent first reaction gas inlet holes.

14. The unit cell of claim 13, wherein the first inlet flow field plate is divided into a support supported on the first reaction surface and a plurality of protrusions protruding from the support, and a flow field through which the first reaction gas flows is formed between the adjacent protrusions.

15. The unit cell of claim 13, wherein a first inlet forming part protrudes in a first reaction surface direction between the first reaction gas inlet manifold and a plurality of first reaction gas inlet holes.

16. The unit cell of claim 15, wherein the first inlet forming part extends from a point in contact with the first reaction gas inlet manifold to a point in contact with the plurality of first reaction gas inlet holes.

17. The unit cell of claim 15, wherein the first reaction surface gasket line is not formed between the first reaction gas inlet manifold and the plurality of first reaction gas inlet holes.

18. The unit cell of claim 15, wherein a second reaction surface gasket line forming an airtight line along an edge of a second manifold communicating with the first reaction gas inlet manifold of the first separator is formed on the second reaction surface of the second separator, and an uneven part corresponding to a bent shape of at least one end of the first inlet forming part formed on the first separator is formed in the second reaction surface gasket line.

19. The unit cell of claim 12, wherein one of the second manifolds formed on one side of the second reaction region in the second separator is a second reaction gas inlet manifold through which a second reaction gas is introduced;
a plurality of second reaction gas inlet holes are formed between the second reaction gas inlet manifold and the second reaction region such that the second reaction gas flowing from the second reaction gas inlet manifold through the second cooling surface passes through the second reaction surface and then flows into the second reaction region; and
a second inlet flow field plate is positioned on the second reaction surface to prevent deformation of the second separator while forming a flow field through which the second reaction gas flows between the plurality of second reaction gas inlet holes and the second reaction region.

20. The unit cell of claim 19, wherein the plurality of second reaction gas inlet holes formed in the second separator is formed in a line at a predetermined distance apart along a width direction of the second separator perpendicular to a direction in which the second reaction gas flows;
a second reaction surface gasket line is formed around the plurality of second reaction gas inlet manifolds to form an airtight line along an edge of the second reaction gas inlet manifold; and
the second reaction surface gasket line is not formed between the adjacent second reaction gas inlet holes.
